(19) United States
(12) Patent Application Publication
(10) Pub. No.: US 2026/0225365 A1
(43) Pub. Date: Aug. 6, 2026

(54) LIQUID DISCHARGE HEAD SUBSTRATE AND LIQUID DISCHARGE HEAD

(71) Applicant: CANON KABUSHIKI KAISHA, Tokyo (JP)

(72) Inventors: TAICHI YONEMOTO, Kanagawa (JP); ATSUNORI TERASAKI, Kanagawa (JP); SOUTA TAKEUCHI, Kanagawa (JP)

(21) Appl. No.: 19/358,256

(22) Filed: Oct. 14, 2025

(30) Foreign Application Priority Data
Oct. 22, 2024 (JP) 2024-186258

(51) Int. Cl. B41J 2/14; B41J 2/16

(52) U.S. Cl. CPC B41J 2/14201; B41J 2/1607; B41J 2/1623; B41J 2/1628; B41J 2/1629; B41J 2/1631; B41J 2/1642; B41J 2002/14491

(57) ABSTRACT

A liquid discharge head substrate includes a discharge element for discharging ink, an electrode pad electrically connected to the discharge element via a wiring. The electrode pad is disposed on the wiring. At least a part of a side surface of the electrode pad is covered by an inorganic film.

### BACKGROUND

### Field of the Technology

The present disclosure relates to a liquid discharge head substrate and a liquid discharge head.

### Description of the Related Art

A liquid discharge head of a liquid discharge apparatus performs a recording operation or the like by discharging liquid, such as ink, from discharge ports, using pressure generated by vibrating the liquid through discharge energy produced by energizing an energy element.

In the liquid discharge head, an electrical connection portion connecting a terminal on a liquid discharge substrate including discharge ports and a wiring portion on a wiring substrate is sealed with a sealing agent containing resin as a main component. However, if the sealing with the sealing agent is not sufficient, there is a possibility that ink may enter the electrical connection portion and cause corrosion of a terminal portion. For this reason, for the liquid discharge head, various measures have been taken to prevent corrosion of the electrical connection portion.

For example, Japanese Patent Laid-open No. 2008-207543 describes a configuration in which the side surfaces of terminals are coated with a resin material so as to prevent the terminals from being corroded by ink. The technique described in Japanese Patent Laid-open No. 2008-207543 enables the terminal and the sealing material less likely to peel off by covering the side surfaces of the terminal with the resin material.

### SUMMARY

As the requirements for thinning and planarization accuracy of a liquid ejection substrate increase in response to demands for high-resolution recording and the like, it becomes difficult to accurately cover terminals with a resin layer.

Thus, in view of the above described disadvantage, the present disclosure is directed to providing a liquid discharge head with high electrical reliability.

According to an aspect of the present disclosure, a liquid discharge head substrate includes a discharge element for discharging ink, an electrode pad electrically connected to the discharge element via a wiring. The electrode pad is disposed on the wiring. At least a part of a side surface of the electrode pad is covered by an inorganic film.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an example of a liquid discharge apparatus.

FIG. 2 is a perspective view illustrating an example of a liquid discharge head.

FIG. 3 is a perspective view illustrating an example of a liquid discharge unit.

FIG. 4 is an exploded perspective view illustrating an example of the liquid discharge unit.

FIG. 5 is a plan view illustrating a discharge chip according to a first embodiment.

FIG. 6 is an enlarged plan view illustrating the discharge chip according to the first embodiment.

FIG. 7 is a cross-section view illustrating the discharge chip according to the first embodiment.

FIG. 8 is a cross-section view illustrating an electrode pad according to the first embodiment.

FIG. 9 is a cross-section view illustrating the discharge chip connected to a wiring according to the first embodiment.

FIG. 10 is a cross-section view illustrating the discharge chip connected to the wiring according to the first embodiment.

FIGS. 11A to 11I are cross-section views illustrating a part of manufacturing processes for the discharge chip according to the first embodiment.

FIG. 12 is a cross-section view illustrating an electrode pad according to a second embodiment.

FIGS. 13A to 13I are cross-section views illustrating a part of manufacturing processes for a discharge chip according to a third embodiment.

FIG. 14 is a cross-section view illustrating an electrode pad according to an example 2.

### DESCRIPTION OF THE EMBODIMENTS

Embodiments of the present disclosure will be described with reference to the accompanying drawings. The components having the same functions are assigned the same numerals, and the redundant descriptions thereof may sometimes be omitted. Hereinbelow, examples in which the present disclosure is applied to a liquid discharge head mounted on an inkjet printer serving as a liquid discharge apparatus will be described. However, the present disclosure is not limited to the embodiments described below, and may be added to, modified, or partially deleted within the scope that can be conceived by those skilled in the art. Any configuration that achieves the advantages and effects of the present disclosure is considered to fall within the scope of the present disclosure.

Note that the components described in the following embodiments are merely examples, and they are not intended to limit the range of the present disclosure only thereto. In the present disclosure, a specific example using a liquid discharge recording head is described, but it is not limited thereto, and various modifications and changes are possible within the range of the gist of the disclosure.

### First Embodiment

### Configuration of Liquid Discharge Apparatus

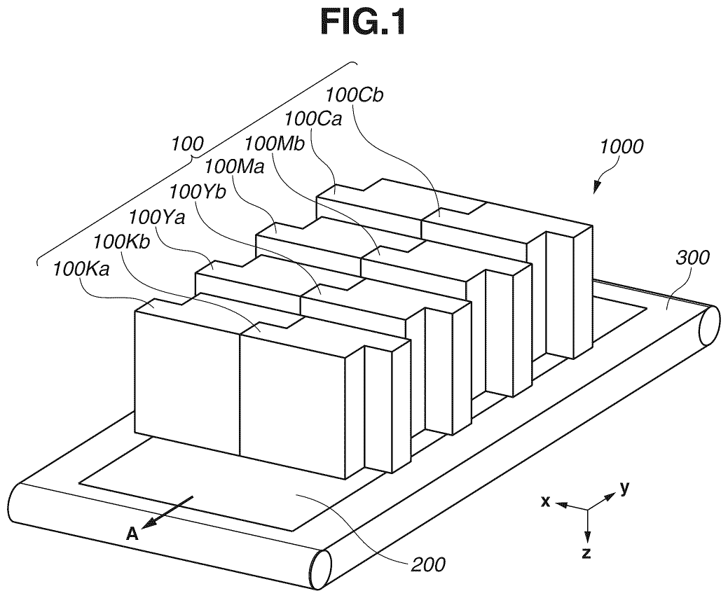

FIG. 1 is a schematic perspective view illustrating a general configuration of a liquid discharge apparatus 1000 according to an embodiment of the liquid discharge apparatus to which the present disclosure is applicable. The liquid discharge apparatus 1000 according to the present embodiment is of a single-pass type in which an image is recorded on a recording medium 200 by a single movement of the recording medium 200, and discharge ports for discharging liquid are arranged so that the full width of the recording medium 200 is covered. The liquid discharge apparatus 1000 is provided with liquid discharge heads 100, for example, in an attachable and detachable manner.

The recording medium 200 is conveyed by a conveyance unit 300 in an arrow “A” direction, and the liquid discharge heads 100 perform recording on the recording medium 200. Each of the liquid discharge heads 100 (described below) includes liquid discharge units 21 arranged on a support member. Each of the liquid discharge units 21 includes a discharge chip 20 capable of discharging liquid. Each of the liquid discharge heads 100 is positioned in the liquid discharge apparatus 1000 by a reference member. FIG. 1 illustrates the liquid discharge apparatus 1000 including total eight liquid discharge heads 100 (i.e., 100Ka, 100Kb, 100Ya, 100Yb, 100Ma, 100Mb, 100Ca, and 100Cb) capable of discharging four colors of inks, specifically, black, yellow, magenta, and cyan. The eight liquid discharge heads 100 include two liquid discharge heads 100 for each color.

Herein, a direction parallel to and opposite to a conveyance direction “A” of the recording medium 200 is defined as a Y direction, a direction from the liquid discharge heads 100 to the recording medium 200 is defined as a Z direction, and a direction perpendicular to both the Y and Z directions, and perpendicular to the conveyance direction “A” of the recording medium 200 is defined as an X direction.

### Overall Configuration of Liquid Discharge Head

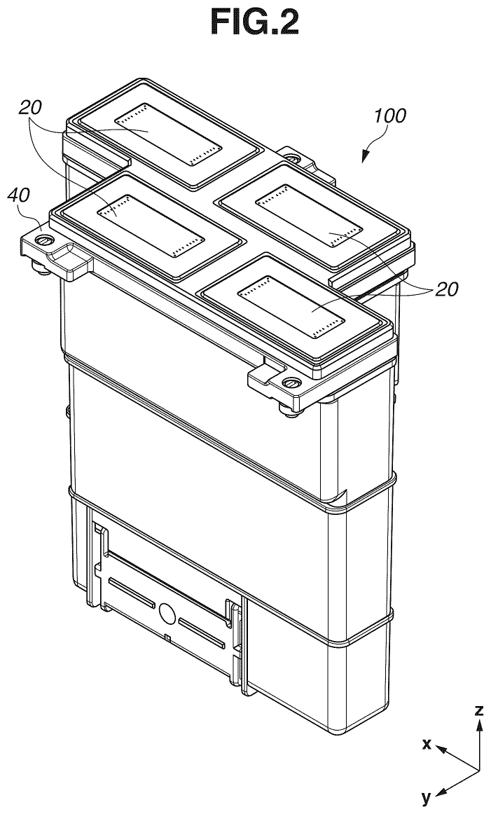

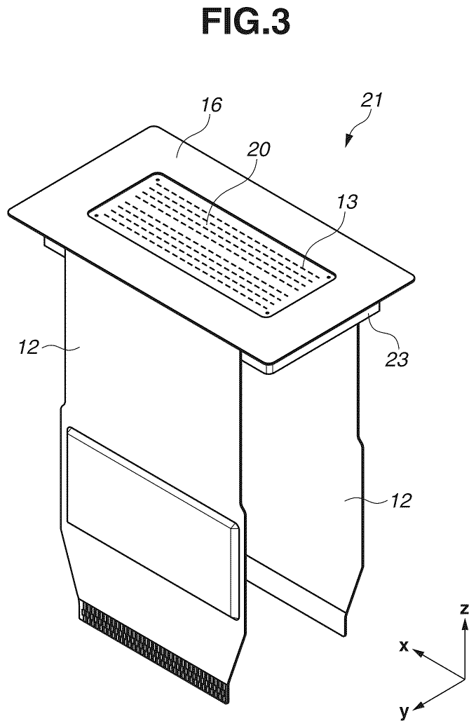

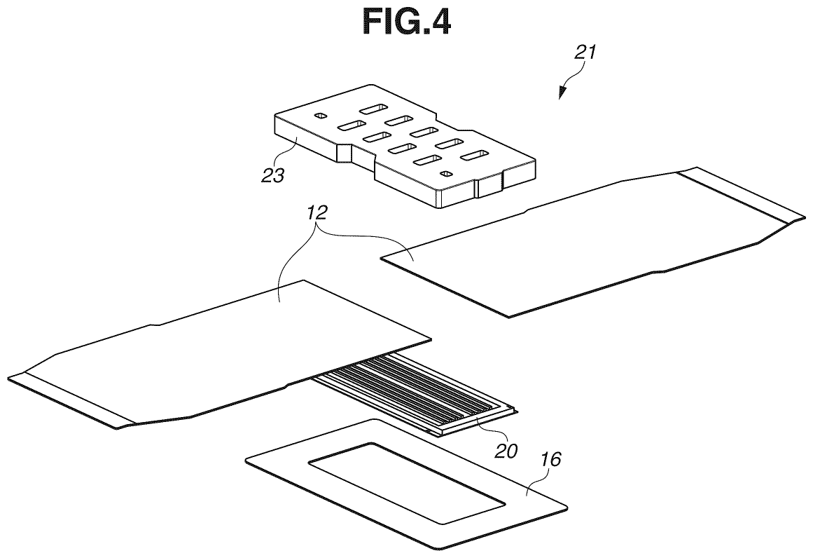

FIG. 2 is a perspective view of one of the liquid discharge heads 100, and FIG. 3 is a perspective view illustrating one of the liquid discharge units 21. In the liquid discharge head 100 according to the present embodiment, a plurality of the liquid discharge units 21 each including the discharge chip 20 having discharge ports for discharging liquid is fixed on a support member 40. The liquid discharge unit 21 includes a cover member 16 on a surface of the discharge chip 20 opposite to the support member 40 (see FIGS. 3 and 4). The liquid discharge head 100 further includes a housing for accommodating an electric substrate and the like. The liquid discharge head 100 to which the present disclosure is applicable can be implemented in any form including the example illustrated in FIG. 2, and other embodiments are not limited thereto. Hereinafter, one of the plurality of liquid discharge heads 100 may be described as a representative example. In addition, one of the plurality of the liquid discharge units 21 may be described as representative example.

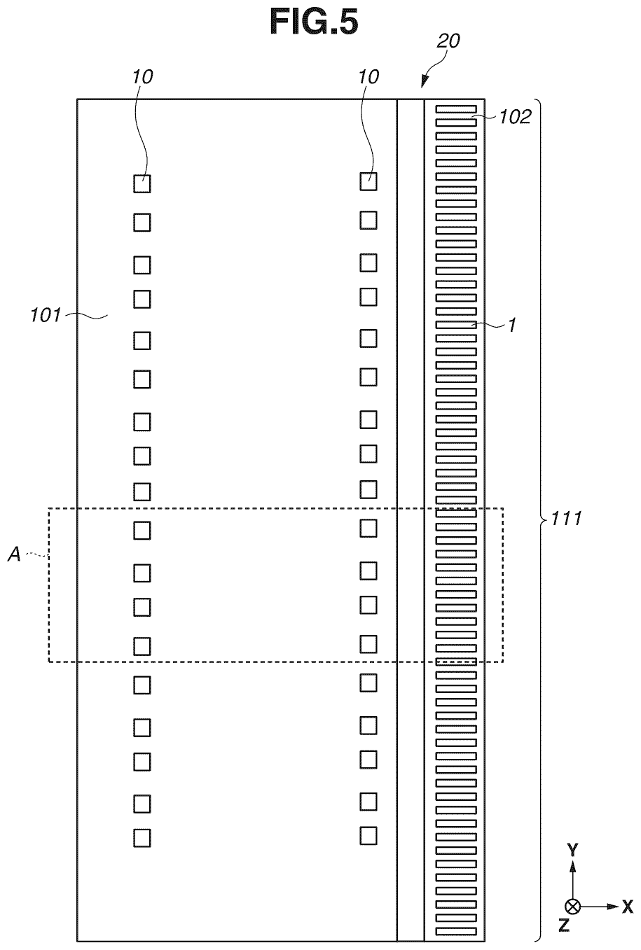

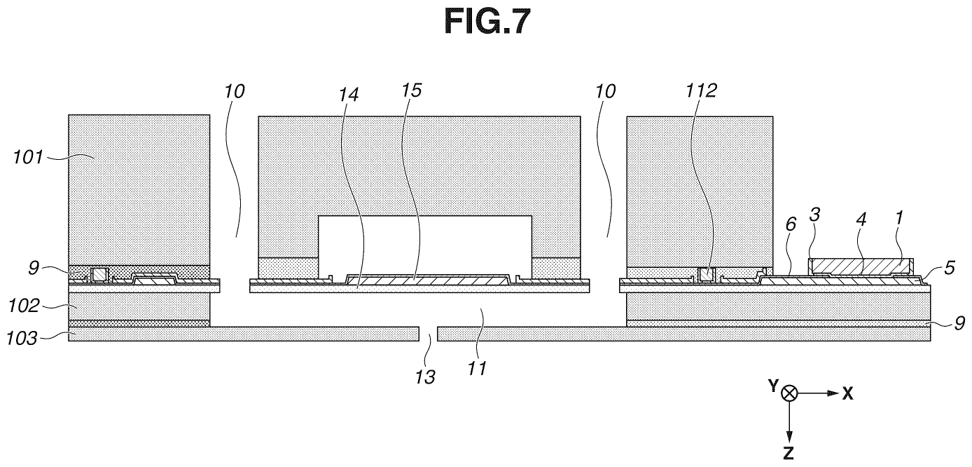

FIG. 4 is an exploded perspective view illustrating the liquid discharge unit 21 viewed from the opposite side of the surface (front surface) in which discharge ports 13 of the discharge chip 20 are disposed. The liquid discharge unit 21 includes the discharge chip 20, electric wiring members (wiring substrates) 12, and a flow path member 23. The discharge chip 20 includes the discharge ports 13 for discharging liquid therefrom, the discharge element 15 serving as an actuator (see FIG. 7) used for discharging the liquid from the discharge ports 13, and terminals 1 (see FIG. 5) electrically connected to the actuators. The electric wiring members 12 are connected to the terminals 27 to supply electric power for driving respective actuators from the outside of the discharge chip 20 to pressure generation elements included in the actuators. The flow path member 23 includes flow paths for supplying liquid to the respective discharge ports 13, and arranged adjacent to the discharge chip 20 on the backside, which is the surface opposite to the front surface of the discharge chip 20. Each of the electric wiring members 12 is connected to the terminals 27 of the discharge chip 20, on the backside of the discharge chip 20, to form an electrical connection portion. In the present embodiment, the liquid discharge unit 21 further includes the cover member 16 for protecting the front surface of the discharge chip 20. In the present embodiment, as an example, alumina is used for the flow path member 23, titanium is used for the cover member 16.

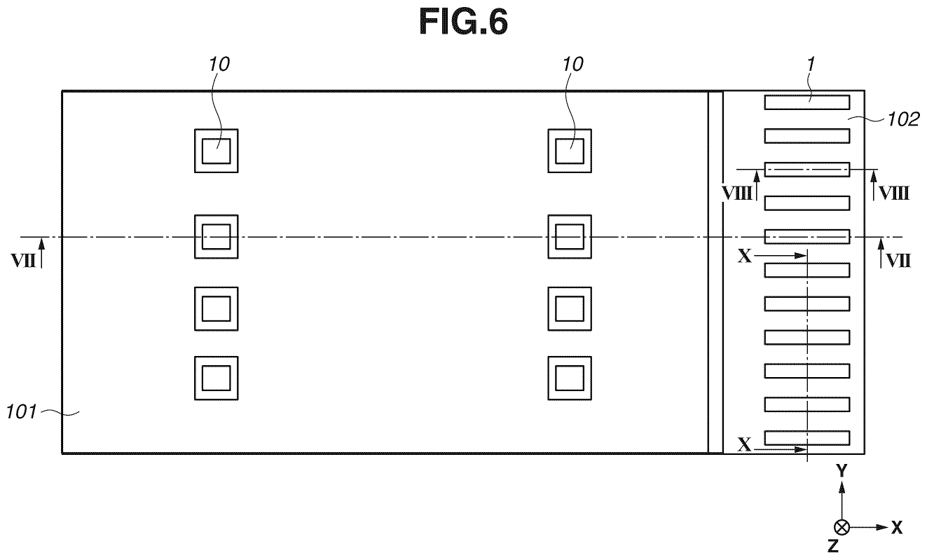

FIG. 5 is a plan view illustrating the discharge chip 20 (liquid discharge substrate) viewed from the surface on which a terminal portion is disposed, in a state prior to being electrically connected to the electric wiring member 12. FIG. 6 is an enlarged view in which a portion A in FIG. 5 is enlarged. FIG. 7 is a cross-section view, taken along a line VII-VII in FIG. 6.

FIG. 7 is a schematic cross-section view of the discharge chip 20, which is a liquid discharge head substrate according to the embodiment of the present disclosure. The discharge chip 20 includes a first substrate 101, a second substrate 102, and a third substrate 103.

The first substrate 101 is formed of, for example, a silicon substrate, and has a configuration that a discharge element 15 is formed on a vibration plate 14. The second substrate 102 has an opening for forming a pressure chamber 11. The vibration plate 14 defines a top wall of the pressure chamber 11, and partitions a plurality of the pressure chambers 11.

Further, in the first substrate 101, a storage portion for a piezoelectric element serving as the discharge element 15, and individual flow paths 10 for introducing liquid into the pressure chamber 11 are formed. In the configuration according to the present embodiment illustrated in FIG. 7, two individual flow paths 10 are connected to one pressure chamber 11, thus enabling liquid, such as ink, to circulate inside and outside the pressure chamber 11.

In the present embodiment, an upper part of the joined substrate is formed by joining the first substrate 101 and the second substrate 102 via an adhesive agent 9. In the present embodiment, the piezoelectric element storage portion and the individual flow paths 10 are formed in the first substrate 101, and the pressure chamber 11 is formed in the second substrate 102. In the piezoelectric element storage portion, a plurality of piezoelectric elements is stored such that each of them corresponds to the corresponding one(s) of a plurality of the pressure chambers 11.

The third substrate 103 is formed of, for example, a silicon substrate, and the discharge port 13 for discharging liquid is formed. The discharge port 13 penetrates the third substrate 103, which is a discharge port substrate having a discharge port 13 on the opposite side of the pressure chamber 11. Accordingly, when a volume change occurs in the pressure chamber 11, the liquid stored in the pressure chamber 11 is discharged from the discharge port 13.

### Configuration of Electrode Pad

In the liquid discharge substrate according to the present embodiment, the first substrate 101, the second substrate 102, and the third substrate 103 are stacked in this order. Each of the first substrate 101 to the third substrate 103 according to the present embodiment is formed of a silicon substrate. These substrates are joined via the adhesive agent 9.

The third substrate 103 is a discharge port substrate including the discharge port 13. The second substrate 102 is an actuator substrate including the pressure chamber 11 communicating with the discharge port 13, the vibration plate 14, and the discharge element 15 provided on the surface of the vibration plate 14 opposite to the pressure chamber 11. The discharge element 15 according to the present embodiment illustrated in FIG. 7 is a piezoelectric element. The second substrate 102 further includes a wiring layer 5 for supplying a driving signal and a voltage to the discharge element 15. The wiring layer 5 is electrically connected to the discharge element 15 via a wiring (not illustrated). The wiring layer 5 is coated by a wiring coating layer 6 made of an insulation material such as a silicon compound, for example, silicon nitride (SiN). The first substrate 101 is provided with the individual flow paths 10 for supplying liquid to each of the pressure chambers 11.

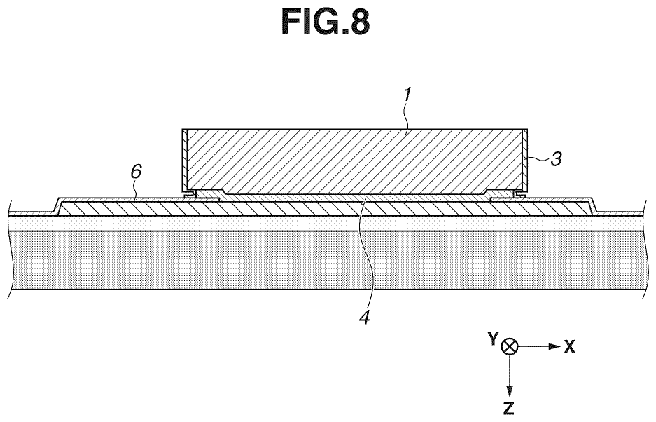

FIG. 8 is an enlarged cross-section view illustrating an electrode pad 1 and the wiring layer 5 and the vicinity thereof, taken along the line VIII-VIII in FIG. 6. On the wiring layer 5, the wiring coating layer 6 is provided with an opening to electrically connect the wiring layer 5 and the electrode pad 1 made of gold (Au) via the opening. The electrode pad 1 is provided on the wiring layer 5 (on wiring). To prevent the gold constituting the electrode pad 1 from diffusing into the wiring layer 5, which is a wiring made of aluminum or the like, the wiring layer 5 and the electrode pad 1 are electrically connected via a titanium tungsten (TiW) layer serving as a diffusion prevention layer 4. A layer having a composition other than TiW may be used as the diffusion prevention layer 4. As described above, the terminal portion at which the discharge chip 20 is electrically connected to the electric wiring member 12 is configured by stacking the wiring layer 5, the diffusion prevention layer 4, and the electrode pad 1 on the second substrate 102 in this order.

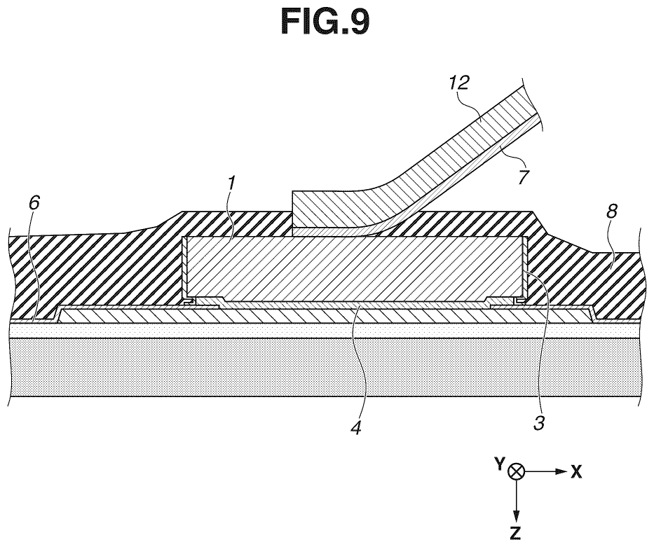

The terminal portion is connected to a wiring 7 included in the electric wiring member 12 as illustrated in FIG. 9 so that the discharge chip 20 is electrically connected to the liquid discharge apparatus 1000. FIG. 9 is a cross-section view illustrating a state where the wiring 7 is electrically connected to the electrode pad 1, and illustrating a position corresponding to FIG. 8. The terminal portion (electrode pad 1) and the wiring 7 can be connected using any method, for example, a type of a flip-chip bonding electrode sealing method such as wire bonding or non-conductive paste (NCP) joining. The liquid discharge apparatus 1000 supplies, via the terminal portion, an electrical signal (driving signal) for determining a driving timing of the discharge element 15, and a voltage for driving the discharge element 15. The wiring 7 and the terminal portion including the electrode pad 1 can be protected from ink, moisture, and the like by being sealed with a sealing agent 8, such as epoxy resin.

As illustrated in FIG. 8, when viewed from a direction perpendicular to the surface of the discharge chip 20, an adhesive layer 3 is provided on the side surfaces of the electrode pad 1, and around the diffusion prevention layer 4 in the vicinity of the electrode pad 1. The adhesive layer 3 is an inorganic film including metal oxide or silicon, or a layered film including both of them, provided so as to surround the side surfaces of the electrode pad 1. The “side surfaces of the electrode pad 1” in the present disclosure indicate the surfaces extending in a direction intersecting with the surface of the discharge chip 20. The adhesive layer 3 is not present on a connection portion between the electrode pad 1 and the wiring 7, but is provided on the side surfaces of the electrode pad 1, thus functioning as a layer that improves the adhesion between the sealing agent 8, which is a resin layer, and the electrode pad 1. Thus, the adhesive layer 3 does not necessarily need to be formed over the entire side surfaces of the electrode pad 1, and may be partially discontinuous, as long as the adhesive layer 3 is formed at a part between the side surfaces of the electrode pad 1 and the sealing agent 8. If ink infiltrates from the interface between the wiring coating layer 6 and the sealing agent 8 due to poor adhesion therebetween, the sealing agent 8 will not peel off, because the adhesion between the sealing agent 8 and the electrode pad 1 is ensured by the adhesive layer 3. Accordingly, infiltration of ink into the wiring layer 5, which serves as a wiring layer, is prevented.

As for the adhesion of each member, the adhesion between the adhesive layer 3 and the sealing agent 8 can be higher than the adhesion between the electrode pad 1 and the sealing agent 8. Further, the adhesion between the electrode pad 1 and the adhesive layer 3 can be higher than the adhesion between the sealing agent 8 and the adhesive layer 3.

The adhesive layer 3 can be made of a composition having ink resistance properties. More specifically, silicon carbide (SiC), silicon oxycarbide (SiOC), silicon carbonitride (SiCN), silicon oxide carbon nitride (SiOCN), titanium oxide (TiO), tantalum oxide (TaO), hafnium oxide (HfO), and zirconium oxide (ZrO) can be appropriately used. These materials can improve the adhesion with organic resin materials, such as the sealing agent 8 and the adhesive agent 9, and can also function as a protection film against ink. Among these materials, since TaO is excellent in adhesiveness with the adhesive agent 9, TaO can be appropriately used for the protection film.

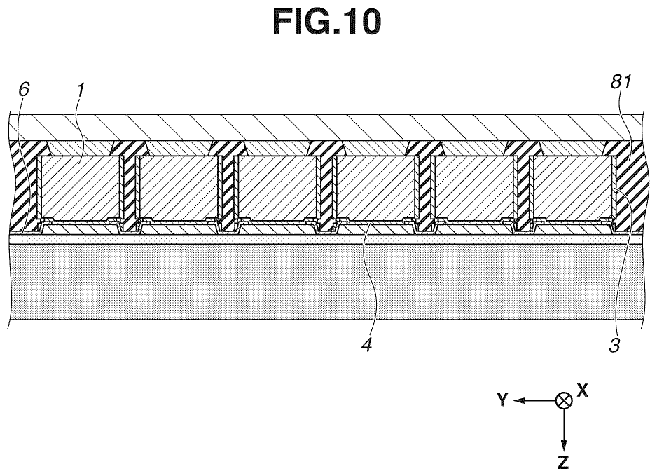

FIG. 10 illustrates a configuration in which the electrode pad 1 and the wiring 7 are connected by NCP joining.

The portion illustrated in FIG. 10 corresponds to a cross section taken along a line X-X in FIG. 6. The procedure for electrical connection in this case will now be described. Initially, a non-conductive resin (NCP resin) 81, which is an organic material, is applied to an area in which the electrode pad 1 is formed. Then, after aligning the electrode pad 1 with the wiring 7, a bonding tool or the like is used to apply pressure from above the wiring 7, thereby bringing the electrode pad 1 and the wiring 7 into contact with each other.

At this time, it is desirable that the NCP agent 81 be extruded from a contact surface, and that the electrode pad 1 and the wiring 7 be brought into direct contact with each other. Next, while maintaining the state in which the contact position is fixed by the applied pressure, the NCP agent 81 is cured by heating. The curing shrinkage force of the NCP agent 81 maintains the electrical connection between the electrode pad 1 and the wiring 7.

In a case of the NCP connection as described above, the adhesion between the electrode pad 1 and the NCP agent 81, which is an organic material, is important. The adhesion between the NCP agent 81 made of an organic material and the electrode pad 1 made of metal is low, and if the NCP agent 81 peels off from the electrode pad 1, it may sometimes become a cause of a connection failure. Thus, as in the configuration according to the present disclosure, the adhesive layer 3 that is formed on the side surfaces of the electrode pad 1 can maintain high adhesion between the NCP agent 81 and the electrode pad 1.

In a case where the electrode pads 1 are densely arranged on the liquid discharge substrate, and the contact area between each of the electrode pads 1 and the sealing agent 8 or the NCP agent 81 is small, the present disclosure can be suitably applied to improve the adhesion between the electrode pad 1 and the sealing agent 8 or the NCP agent 81.

### Manufacturing Method of Electrode Pad

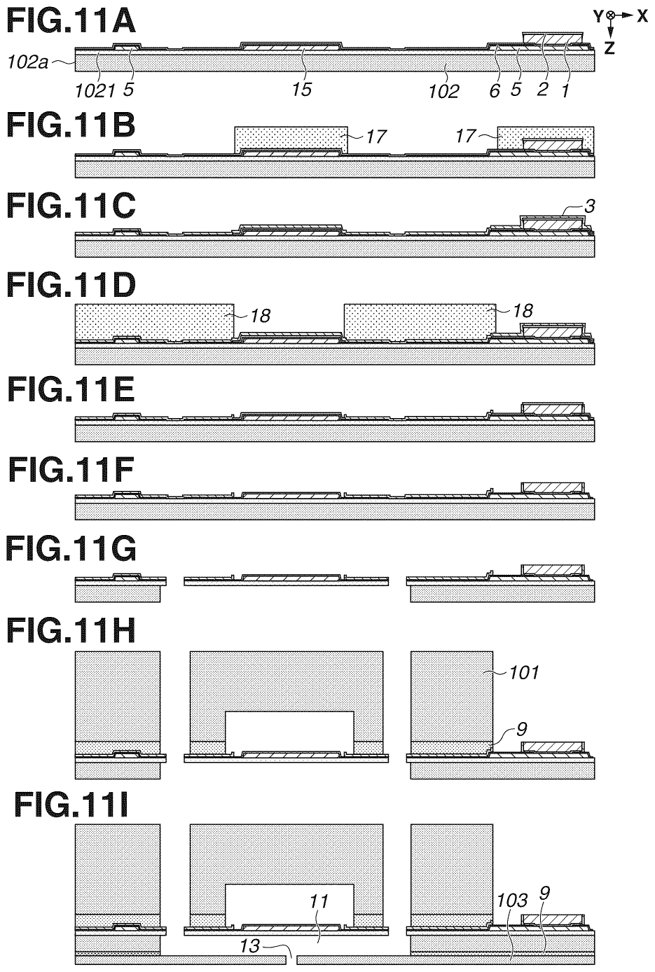

With reference to FIGS. 11A to 11I, a description will now be provided of processes for manufacturing the liquid discharge substrate, including processes for forming the adhesive layer 3 on the side surfaces of the electrode pad 1.

Initially, the second substrate 102 is prepared, in which the discharge element 15, the wiring layer 5, and the electrode pad 1 are formed on a surface layer 1021 located on the surface (first surface) 102a side. In a case where the first substrate 101 is a silicon substrate, examples of the material of the surface of the surface layer 1021 include a silicon based material which is typically used in semiconductor devices and microelectromechanical system (MEMS) devices, such as silicon (Si), SiN, SiC, silicon oxide (SiO), SiOC, silicon oxynitride (SiON), SiCN, or SiOCN. Examples of the material of the electrode pad 1 include aluminum (Al), copper (Cu), gold (Au), iridium (Ir), and tantalum (Ta).

Subsequently, as illustrated in FIG. 11A, a sacrifice layer 2 is deposited on the surface 102a side of the second substrate 102. The sacrifice layer 2 is a layer to be removed in a later process. The process of etching an ink-resistant film without damaging the materials of the substrate and the electrode is difficult. Thus, when the ink-resistant film is etched, the sacrifice layer 2 that can be selectively removed without damaging the materials of the substrate and the electrode is required. In consideration of the above, titanium tungsten (TiW), tungsten (W), chromium (Cr), or the like can be suitably used for the sacrifice layer 2. If no component containing Al or SiO is present on the first substrate 101, Al or SiO may be used for the sacrifice layer 2. When the adhesive layer 3 also functions as an ink-resistant film, materials such as TiO, TaO, HfO, and ZrO are particularly suitable for use as the material of the adhesive layer 3.

Next, a photoresist material is applied on the surface 102a side of the second substrate 102, and a photoresist 17 is patterned by photolithography as illustrated in FIG. 11B. Through this process, the sacrifice layer 2 in an area in which the electrode pad 1 and the discharge element 15 are disposed is covered with the photoresist 17. Next, the sacrifice layer 2 exposed from the photoresist 17 is removed by wet etching or the like, and then the photoresist 17 is removed by etching. Through this process, the sacrifice layer 2 remains on the side surfaces of the electrode pad 1, the side surfaces of the diffusion prevention layer 4, and the area of the discharge element 15 (see FIG. 11C).

Next, as illustrated in FIG. 11C, the adhesive layer 3 is deposited over the entire surface 102a side of the second substrate 102, including sides of the electrode pad 1 and a spacer 112. Examples of the material of the adhesive layer 3 serving also as an ink-resistant film include TiO, TaO, HfO, and ZrO. As the deposition method for the adhesive layer 3, for example, an atomic layer deposition (ALD) method and a chemical vapor deposition (CVD) method can be used. For example, in a case where TaO is deposited as the adhesive layer 3, the ALD method can be used. The ALD method enables isotropic deposition over the entire surface, so that the ALD method can be optimally used for the deposition method for the adhesive layer 3. In a case where SiC is deposited as the adhesive layer 3, the CVD method can be used.

Subsequently, a photoresist material is applied, and a photoresist 18 is patterned as illustrated in FIG. 11D by photolithography. Through this process, the areas of the electrode pad 1 and the discharge element 15 are left without the resist 18.

Next, as illustrated in FIG. 11E, after the adhesive layer 3 exposed from the photoresist 18 is etched, the photoresist 18 is removed. For example, anisotropic dry etching can be used for etching the adhesive layer 3. Through the etching of the adhesive layer 3, the adhesive layer 3 remains under the pattern of the photoresist 18. In the area exposed from the photoresist 18, the adhesive layer 3 on the upper surfaces (surfaces on the opposite side of the second substrate 102) of the electrode pad 1 and the discharge element 15 is removed. On the other hand, the adhesive layer 3 remains on the side surfaces of the electrode pad 1, on the side surfaces of the diffusion prevention layer 4, and in the portion unaffected by the dry etching due to the presence of the electrode pad 1.

In order for the adhesive layer 3 to function, the film thickness of the adhesive layer 3 remaining on the side surfaces of the electrode pad 1 can be 2 nanometer (nm) or more. As long as the adhesive layer 3 serves to increase the adhesion between the electrode pad 1 and the sealing agent 8, the side surfaces of the electrode pad 1 do not necessarily need to be fully covered by the adhesive layer 3. The thickness of the adhesive layer 3 may be non-uniform, and thin and thick portions may coexist.

Here, in order to describe the state of the side surfaces of the electrode pad 1 in a pad array 111 direction, a cross-section view, taken along the line X-X in FIG. 6, is illustrated in FIGS. 11A to 11E. As illustrated in FIGS. 11A to 11E, the adhesive layer 3 is divided between the adjacent electrode pads 1, and the side surfaces of each of the electrode pads 1 is covered by the adhesive layer 3. In this case, if isotropic etching is used for etching the adhesive layer 3, the adhesive layer 3 deposited on the side surfaces of the electrode pad 1 may also be removed. Thus, the anisotropic dry etching can be appropriately used as described above. Through this process, in the pad array 111, the adhesive layer 3 is not continuous between the adjacent electrode pads 1 (see FIG. 10).

Subsequently, as illustrated in FIG. 11F, the sacrifice layer 2 is removed. When the sacrifice layer 2 is removed, the combination of the materials and the removal method may be appropriately selected so that the wiring layer 5, the discharge element 15, and the adhesive layer 3 formed on the second substrate 102 are not damaged and only the sacrifice layer 2 can be selectively removed. Examples of the removal method for the sacrifice layer 2 include wet etching and isotropic dry etching. Through the series of processes described above, the electrode pad 1 with its side surfaces covered by the adhesive layer 3 can be formed.

In addition, prior to etching the adhesive layer 3, it is desirable to set the thickness ratio between the adhesive layer 3 and the sacrifice layer 2 within a range of approximately 0.2 to 5. Regarding the film thickness ratio between the adhesive layer 3 and the sacrifice layer 2, if the sacrifice layer 2 exhibits high performance as a stopper during the etching of the adhesive layer 3, the thickness of the adhesive layer 3 relative to the sacrifice layer 2 may be increased.

Subsequently, as illustrated in FIG. 11G, a recess portion to serve as the pressure chamber 11, and through-holes to serve as the individual flow paths 10 are formed in the second substrate 102.

Next, as illustrated in FIG. 11H, a layer made of an organic resin material is formed on the substrate formed by processing the silicon substrate. Then, the first substrate 101 and the second substrate 102 are joined via the adhesive agent 9. As the adhesive agent 9, for example, a material including benzocyclobutene resin as a main component can be used.

Then, as illustrated in FIG. 11I, the third substrate 103 obtained by forming (processing) the discharge port 13 in the silicon substrate is joined to the second substrate 102 via the adhesive agent 9. Through the series of processes described above, the liquid discharge substrate can be formed.

### Second Embodiment

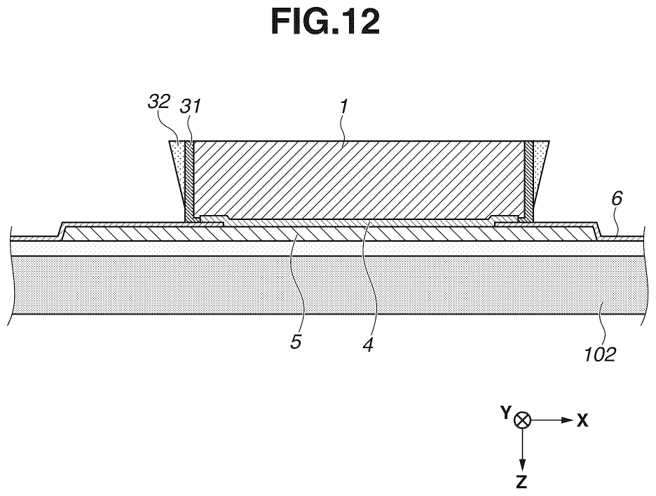

In a second embodiment, points different from the above-described first embodiment will be mainly described, and the descriptions of configurations similar to those described above are omitted. FIG. 12 is a cross-section of the electrode pad 1 according to the second embodiment, and is a view corresponding to FIG. 8 according to the first embodiment.

In the present embodiment, as illustrated in FIG. 12, the side surfaces of the electrode pad 1 are covered by an adhesive layer 31, and the adhesive layer 31 (first layer) is further covered by an adhesive layer 32 (second layer). In other words, the second embodiment has a structure in which the adhesive layer 3 according to the first embodiment has a multi-layer structure. The material similar to that of the adhesive layer 3 described above in the first embodiment can be used for the materials of the adhesive layer 31 and the adhesive layer 32, as long as the adhesion with the sealing agent 8 is higher than the adhesion between the electrode pad 1 and the sealing agent 8.

As for the combination of the materials of the adhesive layer 31 and the adhesive layer 32, it is desirable that the adhesion between the adhesive layer 32 and the sealing agent 8 covering the electrode pad 1 be higher than the adhesion between the adhesive layer 31 and the electrode pad 1. Additionally, it is desirable that the adhesion between the adhesive layer 31 and the electrode pad 1 be higher than the adhesion of the adhesive layer 32 and the electrode pad 1.

A desirable relationship in terms of adhesion strength among the electrode pad 1, the sealing agent 8, the adhesive layer 31, and the adhesive layer 32 is summarized as follows. Regarding adhesion to the electrode pad 1, the order is: adhesive layer 31>adhesive layer 32>sealing agent 8. Regarding adhesion to the sealing agent 8, the order is: adhesive layer 32>adhesive layer 31>sealing agent 8. In other words, in the laminated structure of the adhesive layer 3, it is optimal to arrange a layer with higher adhesion to the electrode pad 1, than other layers, on the side facing the electrode pad 1, and a layer with higher adhesion to the sealing agent 8, than other layers, on the side facing the sealing agent 8.

Using such a combination of the adhesive layer 31 and the adhesive layer 32 can further increase the adhesion between the electrode pad 1 and the sealing agent 8. In this way, it is possible to prevent infiltration of ink into the electrode pad 1, and to enhance the electrical reliability of the liquid discharge head 100. For example, as a specific combination of the materials of the adhesive layer 31 and the adhesive layer 32, TaO for the adhesive layer 31, and SiC, which has a higher adhesion to the resin than TaO, for the adhesive layer 32 can be employed. In this case, as described above, the TaO film serving as the adhesive layer 31 can be deposited using the ALD method, and the SiC film serving as the adhesive layer 32 can be deposited using the CVD method.

In order for the adhesive layers to function, the film thicknesses of the adhesive layer 31 and the adhesive layer 32 remaining on the side surfaces of the electrode pad 1 can be 2 nm or more in total.

As the manufacturing method, in the process illustrated in FIG. 11C, initially, the adhesive layer 31 is deposited, and then the adhesive layer 32 is deposited.

In FIG. 12 and the above descriptions, the configuration in which two adhesive layers, namely, the adhesive layers 31 and 32, are formed on the side surfaces of the electrode pad 1 is described as an example, but a configuration in which an adhesive layer having a layered structure including three or more layers is formed on the side surfaces of the electrode pad 1 can produce the effect according to the present disclosure.

### Third Embodiment

In a third embodiment, points different from the above-described first and second embodiments will be mainly described, and the descriptions of configurations similar to those described above are omitted.

### Spacer Portion

As illustrated in FIG. 7, on the surface of the second substrate 102 on the first substrate 101 side, a wiring electrically connecting the discharge element 15 and the electrode pad 1, the wiring coating layer 6 covering the wiring, and the spacer 112 are formed. When the first substrate 101 and the second substrate 102 are joined, providing the spacer 112 at a position different from the wiring layer and with a height greater than that of the wiring can bring the first substrate 101 and the spacer 112 into contact and also secure the thickness of the adhesive agent 9 on the wiring coating layer 6.

The spacer 112 has a configuration similar to that of the electrode pad 1, and is formed on the diffusion prevention layer 4 as a structural part made of gold. The side surfaces of the spacer 112 and the diffusion prevention layer 4 are surrounded by the adhesive layer 3 which is disposed in a laminated state and includes an inorganic film containing oxidized metal or silicon, or films containing oxidized metal and silicon. Since the adhesion between the spacer 112 and the adhesive agent 9 affects the adhesion strength at the substrate joining surfaces, the presence of the adhesive layer 3 enables further securing of the adhesion of the spacer side surfaces contacting the adhesive agent 9.

In FIG. 7, an example in which the spacer 112 is arranged on the joining surface between the first substrate 101 and the second substrate 102, but the present embodiment is not limited thereto. For example, in the configuration in which the spacer 112 is arranged on the joining surface between the second substrate 102 and the third substrate 103, the adhesive layer 3 may be provided on the side surfaces of the spacer 112.

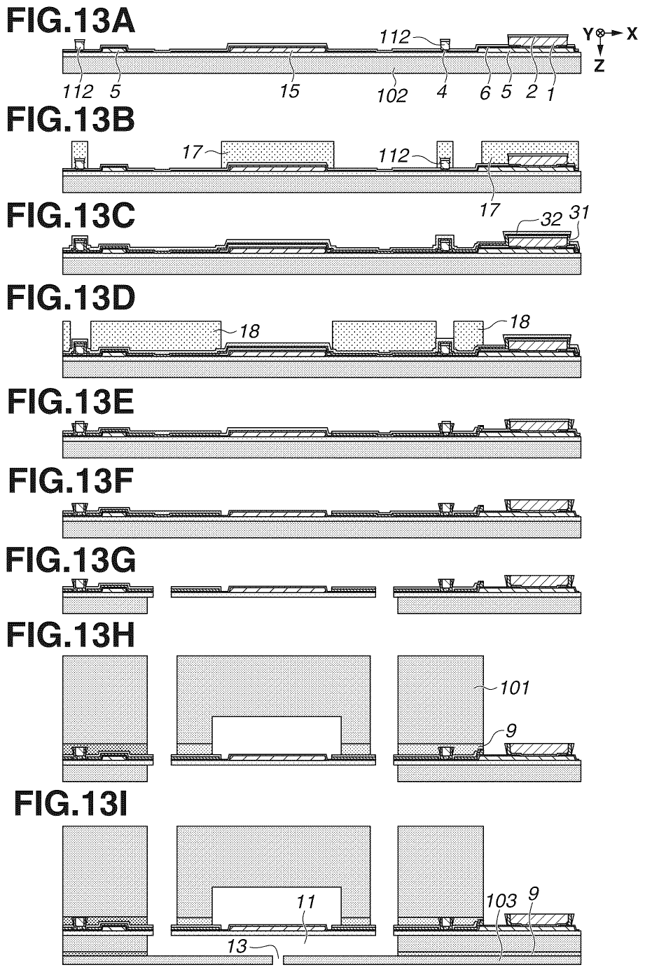

With reference to FIGS. 13A to 13I, manufacturing processes of the liquid discharge substrate including processes for forming the adhesive layer 3 on the side surfaces of the spacer 112 will be described sequentially. In the descriptions below, the adhesive layer 3 is formed also on the side surfaces of the electrode pad 1.

Initially, the second substrate 102 is prepared, in which the discharge element 15, the wiring layer 5, the electrode pad 1, and the spacer 112 are formed on the surface layer 1021 located on the surface 102a side. The spacer 112 can be concurrently formed in the same process as that for the electrode pad 1, and both are formed on the diffusion prevention layer 4. For example, TiW is selected as a material for the diffusion prevention layer 4. The height of the spacer 112 (i.e., the size in a direction perpendicular to the surface 102a of the second substrate 102) is greater than the total thickness of the wiring layer 5 and the cover portion.

Subsequently, as illustrated in FIG. 13A, the sacrifice layer 2 is deposited on the surface 102a side of the second substrate 102. For example, in the present embodiment, a TiW film with a thickness of 50 nm is deposited as the sacrifice layer 2.

Next, a photoresist material is applied to the surface 102a side of the second substrate 102, and the photoresist 17 is patterned by photolithography as illustrated in FIG. 13B. Through this process, the sacrifice layer 2 of an area in which the electrode pad 1, the spacer 112, and the discharge element 15 are disposed bis covered by the photoresist 17. Next, after the sacrifice layer 2 exposed from the photoresist 17 is removed by wet etching or the like, the photoresist 17 is removed by etching. The etching of the TiW film serving as the sacrifice layer 2 can be selectively performed without etching the SiN on the outermost surface of the wiring (Al) by using hydrogen peroxide solution. In a case where the discharge element 15 is a heating resistance element using Ta, it is possible to selectively etch only the TiW film without etching the Ta film. Through this process, the sacrifice layer 2 remains on the side surfaces of the electrode pad 1, the side surfaces of the diffusion prevention layer 4, and in the area of the discharge element 15 (see FIG. 13C).

Next, as illustrated in FIG. 13C, the adhesive layer 3 is deposited over the entire surface 102a side of the second substrate 102, including the side surfaces of the electrode pad 1 and the side surfaces of the spacer 112. In FIG. 13C, the adhesive layer 3 has a two layered structure including the adhesive layer 31 and the adhesive layer 32, a TaO film with a thickness of 20 nm is deposited as the adhesive layer 31, and a SiC film with a thickness of 25 nm is formed as the adhesive layer 32.

Subsequently, the photoresist material is applied, and the photoresist 18 is patterned as illustrated in FIG. 13D by photolithography. Through this process, the photoresist 18 is formed in the areas of the electrode pad 1, the spacer 112, and the discharge element 15.

Next, as illustrated in FIG. 13E, after the adhesive layer 3 exposed from the photoresist 18 is etched, the photoresist 18 is removed. For the etching of the adhesive layer 3, for example, anisotropic dry etching using a fluorocarbon based gas can be used, and the adhesive layer 31 and the adhesive layer 32 can be concurrently etched. The adhesive layer 3 can be processed without damaging the SiN film serving as an outermost surface of the wiring (Al) and the discharge element 15, using a TiW film serving as the diffusion prevention layer 4 as a stopper.

Trough the etching of the adhesive layer 3, the adhesive layer 3 remains under the pattern of the photoresist 18. In the area exposed from the photoresist 18, the adhesive layer 3 on the upper surfaces (surfaces opposite to the second substrate 102) of the electrode pad 1, the spacer 112, and the discharge element 15 is removed. On the other hand, the adhesive layer 3 remains on the side surfaces of the electrode pad 1, the side surfaces of the spacer 112, and the side surfaces of the electrode pad 1, and the side surfaces of the diffusion prevention layer 4 under the spacer 112. In this way, a layer having a high adhesion to the organic resin film including the sealing agent 8 and the adhesive agent 9 can be formed on the side surfaces of the electrode pad 1 and the spacer 112.

Next, as illustrated in FIG. 13F, the sacrifice layer 2 is removed. The TiW film serving as the sacrifice layer 2 can be dissolved and removed by hydrogen peroxide solution. As previously described, treatment with hydrogen peroxide solution does not cause damage to the SiN on the outermost surface of the wiring (Al) or to the outermost surface of the discharge element 15. Similarly, the treatment with hydrogen peroxide solution does not cause damage to the adhesive layer 3.

However, in a case where TiW is used for both the diffusion prevention layer 4 and the sacrifice layer 2, the TiW etching process illustrated in FIGS. 13B and 13E may etch the diffusion prevention layer 4 located directly under the electrode pad 1 and the spacer 112. In this case, the electrode pad 1 and the spacer 112 may possibly peel off. Thus, the processing time for the TiW film can be adjusted so as not to excessively etch the diffusion prevention layer 4. For example, in a configuration such as that of the present embodiment, the dimension of the electrode pad 1 in a horizontal direction (parallel direction to the surface 102a) is presumed to be several tens of micrometers to several hundreds of micrometers. In this case, the amount of etching of the diffusion prevention layer 4 is relatively small compared with the dimension thereof, so that the etching does not affect largely on the electrode pad 1.

Then, as illustrated in FIG. 13G, a recess portion to serve as the pressure chamber 11, and through-holes to serve as the individual flow paths 10 are formed in the second substrate 102.

Next, as illustrated in FIG. 13H, the first substrate 101 and the second substrate 102 are joined via the adhesive agent 9. As the adhesive agent 9, for example, a material containing benzocyclobutene resin as a main component can be used.

Subsequently, as illustrated in FIG. 13I, the third substrate 103 in which the discharge port 13 is processed (formed) in the silicon substrate is joined with the second substrate 102 via the layer of the adhesive agent 9. Through the series of processes described above, a liquid discharge substrate can be formed in which an adhesive layer is provided on the side surface of the electrode pad. The adhesive layer has higher adhesion to the resin than the adhesion between the electrode pad and resin, and higher adhesion to the electrode pad than the adhesion between the resin and the adhesive layer.

### Other Embodiments

The present disclosure is not limited to the above-described embodiments and examples to be described below, and can be modified in various manners within the scope of the technical concept according to the present disclosure. For example, all of or a part of different embodiments and examples can be implemented in combination.

### EXAMPLES

Examples and comparison examples according to the present disclosure will be described below. In addition, the present disclosure will be described in detail. However, the present disclosure is not limited to the following examples.

### Example 1

The liquid discharge head 100 is manufactured according to the processes illustrated in FIGS. 11A to 11I.

Initially, as illustrated in FIG. 11A, a silicon substrate on which the wiring layer 5 and the electrode pad 1 are formed is prepared. The electrode pad 1 made of Au is formed on a TiW film serving as the diffusion prevention layer 4. Then, a TiW film with a thickness of 50 nm is deposited as the sacrifice layer 2 on the surface of the silicon substrate.

Next, as illustrated in FIG. 11B, a pattern of the photoresist 17 is formed on the substrate, and etching of the TiW film serving as the sacrifice layer 2 is performed using the photoresist 17 as a mask. Hydrogen peroxide solution is used for the TiW film etching.

Then, as illustrated in FIG. 11C, a TaO film with a thickness of 45 nm is deposited as the adhesive layer 3.

Subsequently, as illustrated in FIG. 11D, a pattern of the photoresist 18 is formed on the substrate, and the TaO film serving as the adhesive layer 3 is etched using the photoresist 18 as a mask (see FIG. 11E).

At this time, the area of the electrode pad 1 is not covered by the photoresist 18. The etching of the TaO film serving as the adhesive layer 3 is performed by anisotropic dry etching using a fluorocarbon based gas. The adhesive layer 3 can be processed without damaging the wiring and the discharge element 15, using the sacrifice layer 2 (TiW) as a stopper. By the etching of the adhesive layer 3, in the area exposed from the photoresist 18, while the adhesive layer 3 on the upper surfaces (surfaces on the opposite side of the first substrate 101) of the electrode pad 1 and the discharge element 15 is removed, the adhesive layer 3 remains as a film on the side surfaces of the electrode pad 1. Then, as illustrated in FIG. 11E, the photoresist 18 is removed.

Subsequently, as illustrated in FIG. 11F, the TiW film serving as the sacrifice layer 2 is dissolved and removed using hydrogen peroxide solution. As previously described, treatment with hydrogen peroxide solution does not cause damage to the SiN on the outermost surface of the wiring (Al), the outermost surface of the discharge element 15, or the TaO film serving as the adhesive layer 3.

Then, as illustrated in FIG. 11G, a recess portion to serve as the pressure chamber 11, and through-holes to serve as the individual flow paths 10 are formed in the second substrate 102. A common flow path and a supply path are formed in the substrate. In this way, the second substrate 102 is formed.

Subsequently, as illustrated in FIG. 11H, the first substrate 101 and the second substrate 102 are joined via the adhesive agent 9 containing benzocyclobutene resin as a main component. Then, as illustrated in FIG. 11I, the third substrate 103 with the discharge port 13 formed (processed) in the silicon substrate is joined to the second substrate 102 via the adhesive agent 9 containing the benzocyclobutene resin as a main component. Through the above-described series of processes, the liquid discharge substrate is formed.

### Example 2

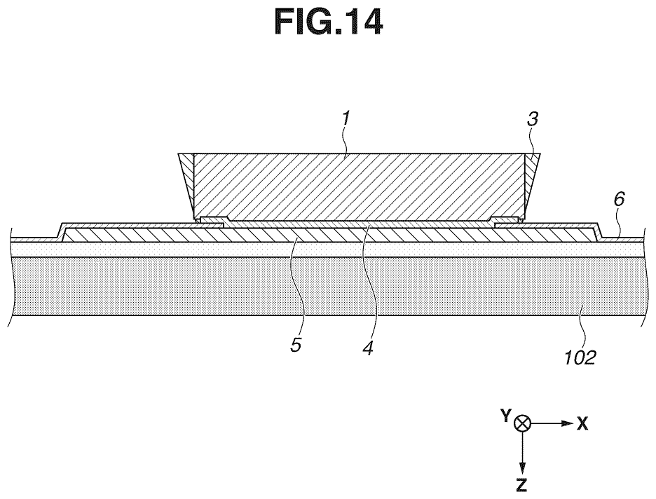

In the example 1, TaO is used for the adhesive layer 3, but in an example 2, SiC is used for the adhesive layer 3. The configurations in the second example are the same as those in the example 1 except for the adhesive layer 3. FIG. 14 is a cross-section view of the electrode pad 1 according to the example 2, and is a view corresponding to FIG. 8 according to the first embodiment.

In the process of depositing the adhesive layer 3 in FIG. 11C, a SiC film with a thickness of 50 nm is deposited.

The etching of the SiC film is performed by anisotropic dry etching using a fluorocarbon based gas.

### Example 3

In the example 1, TaO is used for the adhesive layer 3, and in the example 2, SiC is used for the adhesive layer 3. In an example 3, a layered structure including the adhesive layer 31 formed with TaO, and the adhesive layer 32 formed with SiC is used as the adhesive layer 3. In the process of depositing the adhesive layer 3 in FIG. 13C, a TaO film with a thickness of 20 nm is deposited, and next, a SiC film with a thickness of 25 nm is deposited.

The adhesion strength to the electrode pad 1 formed of Au follows the order: TaO (adhesive layer 31)>SiC (adhesive layer 32>the sealing agent 8. The adhesion strength to the sealing agent 8 follows the order: SiC (adhesive layer 32)>TaO (adhesive layer 31)>the sealing agent 8. In other words, in the layered structure of the adhesive layer 3, a layer with a higher adhesion to the electrode pad 1 is arranged on the electrode pad 1 side, and a layer with a higher adhesion to the sealing agent 8 is arranged on the sealing agent 8 side. Such a configuration can achieve high adhesion between the electrode pad 1 and the sealing agent 8, which improves electrical reliability of the liquid discharge substrate.

According to the present disclosure, a liquid discharge head with a high electrical reliability can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-186258, filed Oct. 22, 2024, which is hereby incorporated by reference herein in its entirety.

What is claimed is:

1. A liquid discharge head substrate comprising:
a discharge element for discharging ink; and
an electrode pad electrically connected to the discharge element via a wiring, the electrode pad being disposed on the wiring;
wherein at least a part of a side surface of the electrode pad is covered by an inorganic film.

2. The liquid discharge head substrate according to claim 1, wherein the electrode pad contains gold (Au).

3. The liquid discharge head substrate according to claim 1, wherein the inorganic film contains a metal oxide.

4. The liquid discharge head substrate according to claim 1, wherein the inorganic film contains at least one compound selected from the group consisting of tantalum oxide, titanium oxide, silicon oxycarbide, hafnium oxide, and zirconium oxide.

5. The liquid discharge head substrate according to claim 1, wherein the composition of the inorganic film is a compound containing silicon.

6. The liquid discharge head substrate according to claim 1, wherein the inorganic film contains at least one compound selected from the group consisting of silicon oxycarbide, silicon carbide, and silicon carbonitride.

7. The liquid discharge head substrate according to claim 1, wherein the inorganic film has a multilayer structure including a first layer and a second layer, the first layer contacting the side surface of the electrode pad, and the second layer being exposed on an opposite side of the first layer.

8. The liquid discharge head substrate according to claim 7, wherein the first layer is a tantalum oxide film, and the second layer is a silicon carbide film.

9. The liquid discharge head substrate according to claim 1, further comprising a wiring configured to electrically connect the discharge element and the electrode pad,
wherein the electrode pad is electrically connected to the wiring via a diffusion prevention layer, and
wherein the inorganic film covers at least a part of a side surface of the diffusion prevention layer.

10. The liquid discharge head substrate according to claim 1, wherein the discharge element is a piezoelectric element.

11. The liquid discharge head substrate according to claim 1, further comprising a pad array in which a plurality of electrode pads including the electrode pad is arranged,
wherein the inorganic film is not connected between adjacent electrode pads of the plurality of electrode pads in the pad array.

12. The liquid discharge head substrate according to claim 1, further comprising:
a second substrate, including the electrode pad, on a first surface of the second substrate;
a wiring, on the first surface, configured to electrically connect the discharge element and the electrode pad;
a first substrate joined with the first surface via an adhesive agent; and
a spacer between the first substrate and the second substrate at a position not overlapping the wiring when viewed from a direction perpendicular to the first surface.

13. A liquid discharge head substrate comprising:
a discharge element for discharging ink;
an electrode pad electrically connected to the discharge element;
a second substrate, including the electrode pad, on a first surface of the second substrate;
a wiring, on the first surface, configured to electrically connect the discharge element and the electrode pad;
a first substrate joined with the first surface via an adhesive agent; and
a spacer between the first substrate and the second substrate at a position not overlapping the wiring when viewed from a direction perpendicular to the first surface,
wherein at least a part of a side surface of the spacer is covered by an inorganic film.

14. The liquid discharge head substrate according to claim 13, wherein the spacer contains gold.

15. A liquid discharge head comprising:
the liquid discharge head substrate according to claim 1;
a wiring substrate including a wiring electrically connected to the electrode pad; and
a sealing material covering a connection portion between the electrode pad and the wiring.

16. The liquid discharge head according to claim 15, wherein the connection portion is formed by non-conductive paste joining, and the sealing material is non-conductive resin.
